(19) United States
(12) Patent Application Publication
(10) Pub. No.: US 2024/0334449 A1
(43) Pub. Date: Oct. 3, 2024

(54) WIRELESS COMMUNICATION METHOD AND DEVICE THEREOF

(71) Applicant: ZTE Corporation, Shenzhen (CN)

(72) Inventors: Jianqiang Dai, Shenzhen (CN); Bo Dai, Shenzhen (CN); Jun Xu, Shenzhen (CN); Mengzhu Chen, Shenzhen (CN); Xiaoying Ma, Shenzhen (CN)

(73) Assignee: ZTE Corporation, Shenzhen (CN)

(21) Appl. No.: 18/735,620

(22) Filed: Jun. 6, 2024

Related U.S. Application Data
(63) Continuation of application No. PCT/CN2022/088318, filed on Apr. 21, 2022.

(51) Int. Cl. H04W 72/231; H04W 72/0446; H04W 72/30; H04W 76/28

(52) U.S. Cl. CPC H04W 72/231; H04W 72/0446; H04W 72/30; H04W 76/28

(57) ABSTRACT

A wireless communication method for use in a wireless terminal is disclosed. The method comprises receiving, from a wireless network node, a first high layer signaling associated with enabling a control information monitoring in a time window or associated with an existence of a service related configuration.

### CROSS-REFERENCE TO RELATED APPLICATION

This application is a continuation of PCT/CN2022/088318, filed on Apr. 21, 2022, titled “WIRELESS COMMUNICATION METHOD AND DEVICE THEREOF”, and published as WO 2023/201665 A1 on Oct. 26, 2023, the entirety of which is incorporated herein by reference.

### TECHNICAL FIELD

This document is directed generally to wireless communications.

### BACKGROUND

The extended Reality (XR) is a term denoting Augmented Reality (AR), Mixed Reality (MR), or Virtual Reality (VR). The technology of XR combines real world and virtual information generated by digital devices. In this way, the XR enables a user to perceive immersive experience in a mixed real-virtual environment. To support a high-quality XR service, both high date rate and low latency are required for the network.

Discontinuous reception (DRX) is a power saving mechanism. For a user equipment (UE) in a connected mode (e.g. RRC_CONNECTED), the DRX is named connected DRX (CDRX). Generally, the CDRX may be conducted to control a physical downlink control channel (PDCCH) monitoring activity of the UE, to save power if the DRX is configured. For example, as shown in FIG. 1, when XR (downlink) traffic(s) arrives at a gNB, when the UE is within each DRX-on period, the gNB can deliver the PDCCH for scheduling DL packets for the XR downlink traffic(s). On the UE (i.e. receiver) side, the PDCCH can be monitored in an interval of the DRX-on state (i.e. on-duration time) and the DL packets may be successfully decoded based on the detected PDCCH. During an interval of a DRX-off state, the UE is not required to monitor the PDCCH, to save power. Therefore, if the packet arrives in that interval, it will be delayed to next on-duration time.

Although the XR traffic is supposed to be periodically generated, variable video encoding time, packet size, network transfer time may result in a certain level of jitter in the XR traffic arriving at the gNB. In some cases, the jitter may not be predictable.

### SUMMARY

This document relates to methods, systems, and devices for control information monitoring, and in particular to methods, systems, and devices for control information monitoring in a specific time window.

The present disclosure relates to a wireless communication method for use in a wireless terminal. The method comprises receiving, from a wireless network node, a first high layer signaling associated with enabling a control information monitoring in a time window or associated with an existence of a service related configuration.

Various embodiments may preferably implement the following features: Preferably, the first high layer signaling is a radio resource control signaling.

Preferably, the first high layer signaling comprises a bit indicating whether the service related configuration exists.

Preferably, the first high layer signaling is broadcasted or unicasted to the wireless terminal.

Preferably, the wireless communication method further comprises receiving, from the wireless network node, a second high layer signaling configuring the time window for the control information monitoring.

Preferably, the second high layer signaling configures the time window by configuring at least one of a duration parameter indicating a duration of the time window or a reference point parameter associated with determining a starting point of the time window.

Preferably, the second high layer signaling configures the time window by configuring a duration parameter indicating a duration of the time window.

Preferably, the duration parameter indicates the duration by indicating a number of search space sets, a number of physical downlink control channel monitoring occasions, a number of slots or a time-domain value.

Preferably, the time window is configured to start at a first physical downlink control channel monitoring occasion, or at a first symbol of a first slot after an expiry of an onDurationTimer or an inactivityTimer

Preferably, a first physical downlink control channel monitoring occasion in the time window or a first slot of the time window is after a time instant which is a time offset after a slot at which an onDurationTimer or an inactivityTimer starts or ends.

Preferably, a unit of the time offset is millisecond or slot.

Preferably, a starting point of the time window is determined based on a start or an end of an onDurationTimer.

Preferably, the time window starts or ends at a time instant having a time offset with respect to a time-domain resource of a last configured grant physical uplink shared channel or a last semi persistent scheduling physical downlink shared channel.

Preferably, the wireless communication method further comprises receiving, from the wireless network node, a third high layer signaling indicating at least one of a system frame number index, a subframe index and a slot index as a starting point of the time window.

Preferably, the wireless communication method further comprises:
activating the control information monitoring in the time window, or
activating a timer associated with the time window, wherein the activated timer is configured by an RRC signaling.

Preferably, the timer is an onDurationTimer or an inactivityTimer.

Preferably, the wireless communication method further comprises receiving, from the wireless network node, an indication associated with activating time window or the timer.

Preferably, the indication comprises downlink control information, DCI, a DCI format, a DCI bit field, a media access control control element, MAC CE, or a reference signal.

Preferably, the DCI is received in:
a last physical downlink control channel monitoring occasion, PDCCH MO, in a timer interval of a running onDurationTimer or a running inactivityTimer, or
a first PDCCH MO after an expiry of the onDurationTimer or in a DRX-off period.

Preferably, the indication is configured with a valid time indicating a number of DRX cycles in which the indication is valid.

Preferably, activating the control information monitoring in the time window or activating the timer associated with the time window comprises:
activating the control information monitoring in the time window or the timer when:
detecting no physical downlink control channel with a cyclic redundancy check scrambled by a radio network temporary indicator allocated for a specific transmission before an onDurationTimer or an inactivityTimer expires,
an onDurationTimer expires and an inactivityTimer is not activated,
an inactivityTimer expires and a starting point of the time window has passed, or
a physical downlink control channel monitoring occasion for an activation/deactivation of a configured grant or a semi persistent scheduling is in the time window.

Preferably, the wireless communication method further comprises monitoring a physical downlink control channel when a behavior of monitoring control information in the time window is activated or the activated timer is running.

Preferably, the monitored PDCCH comprises at least one of a DCI format configured for a specific transmission, or a DCI format having a cyclic redundancy check scrambled by a radio network temporary indicator allocated for the specific transmission.

Preferably, the specific transmission is a quasi-periodic traffic or an extended reality traffic.

Preferably, the wireless communication method further comprises monitoring a physical downlink control channel in a period of non-active time when:
detecting no physical downlink control channel with a cyclic redundancy check scrambled by a radio network temporary indicator allocated for a specific transmission before an onDurationTimer or an inactivityTimer expires, or
an onDurationTimer expires and an inactivityTimer is not activated.

Preferably, the monitored PDCCH comprises at least one of a DCI format configured for a specific transmission, or a DCI format having a cyclic redundancy check scrambled by a radio network temporary indicator allocated for the specific transmission.

Preferably, the specific transmission is a quasi-periodic traffic or an extended reality traffic.

Preferably, the wireless communication method further comprises starting an inactivityTimer after an onDurationTimer expires when:
the onDurationTimer expires and the inactivityTimer does not start, or
detecting no physical downlink control channel with a cyclic redundancy check scrambled by a radio network temporary indicator allocated for a specific transmission before the onDurationTimer or the inactivityTimer expires.

The present disclosure further relates to a wireless communication method for use in a wireless network node, the method comprising:
transmitting, to a wireless terminal, a first high layer signaling associated with enabling a control information monitoring in a time window or associated with an existence of a service related configuration.

Various embodiments may preferably implement the following features:

Preferably, the first high layer signaling is a radio resource control signaling.

Preferably, the first high layer signaling comprises a bit indicating whether the service related configuration exists.

Preferably, the first high layer signaling is broadcasted or unicasted to the wireless terminal.

Preferably, the wireless communication method further comprises transmitting, to the wireless terminal, a second high layer signaling configuring the time window for the control information monitoring.

Preferably, the second high layer signaling configures the time window by configuring at least one of a duration parameter indicating a duration of the time window or a reference point parameter associated with determining a starting point of the time window.

Preferably, the second high layer signaling configures the time window by configuring a duration parameter indicating a duration of the time window.

Preferably, the duration parameter indicates the duration by indicating a number of search space sets, a number of physical downlink control channel monitoring occasions, a number of slots or a time-domain value.

Preferably, the time window is configured to start at a first physical downlink control channel monitoring occasion, or at a first symbol of a first slot after an expiry of an onDurationTimer or an inactivityTimer.

Preferably, a first physical downlink control channel monitoring occasion in the time window or a first slot of the time window is after a time instant which is a time offset after a slot at which an onDurationTimer or an inactivityTimer starts or ends.

Preferably, a unit of the time offset is millisecond or slot.

Preferably, a starting point of the time window is determined based on a start or an end of an onDuration Timer.

Preferably, the time window starts or ends at a time having a time offset with respect to a time-domain resource of a last configured grant physical uplink shared channel or a last semi persistent scheduling physical downlink shared channel.

Preferably, the wireless communication method further comprises transmitting, to the wireless terminal, a third high layer signaling indicating at least one of a system frame number index, a subframe index or a slot index as a starting point of the time window.

Preferably, the wireless communication method further comprises:
transmitting control information being monitored in the time window, or
transmitting an indication to activate a timer in the time window, wherein the activated timer is configured by an RRC signaling.

Preferably, the timer is an onDuration timer or an inactivityTimer.

Preferably, the indication comprises downlink control information, DCI, a DCI format, a DCI bit field, a media access control control element or a reference signal.

Preferably, the DCI is transmitted in:
a last physical downlink control channel monitoring occasion, PDCCH MO, in a timer interval of a running onDurationTimer or a running inactivityTimer, or
a first PDCCH MO after an expiry of the onDurationTimer or in a DRX-off period.

Preferably, the indication is configured with a valid time indicating a number of DRX cycles in which the indication is valid.

The present disclosure further relates to a wireless terminal. The wireless terminal comprises:
a communication unit, configured to receive, from a wireless network node, a first high layer signaling associated with enabling a control information monitoring in a time window or associated with an existence of a service related configuration.

Various embodiments may preferably implement the following feature:

Preferably, the wireless terminal further comprises a processor configured to perform a wireless communication method recited in any one of foregoing methods.

The present disclosure further relates to a wireless network node. The wireless network node comprises:
a communication unit, configured to transmit, to a wireless terminal, a first high layer signaling associated with enabling a control information monitoring in a time window or associated with an existence of a service related configuration.

Various embodiments may preferably implement the following feature:

Preferably, the wireless network node further comprises a processor configured to perform a wireless communication method recited in any one of foregoing methods.

The present disclosure relates to a computer program product comprising a computer-readable program medium code stored thereupon, the code, when executed by a processor, causing the processor to implement a wireless communication method recited in any one of foregoing methods.

The exemplary embodiments disclosed herein are directed to providing features that will become readily apparent by reference to the following description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows a schematic diagram of XR traffic.

FIG. 2 shows a schematic diagram of the configured time period according to an embodiment of the present disclosure.

FIG. 3 shows a schematic diagram of the configured period of time according to an embodiment of the present disclosure.

FIG. 4 shows a schematic diagram of the time window according to an embodiment of the present disclosure.

FIG. 5 shows a schematic diagram of the time window according to an embodiment of the present disclosure.

FIG. 6 shows a schematic diagram of the valid time for Activation of timer according to an embodiment of the present disclosure.

FIG. 7 shows a schematic diagram of the PDCCH monitoring skipping/SSSG according to an embodiment of the present disclosure.

FIG. 8 shows a schematic diagram of the time window according to an embodiment of the present disclosure.

FIG. 9 shows an example of a schematic diagram of a wireless terminal according to an embodiment of the present disclosure.

FIG. 10 shows an example of a schematic diagram of a wireless network node according to an embodiment of the present disclosure.

FIGS. 11 and 12 are flowcharts of methods according to embodiments of the present disclosure.

### DETAILED DESCRIPTION

The mechanism of starting the drx-onDurationTimer is illustration as the following.

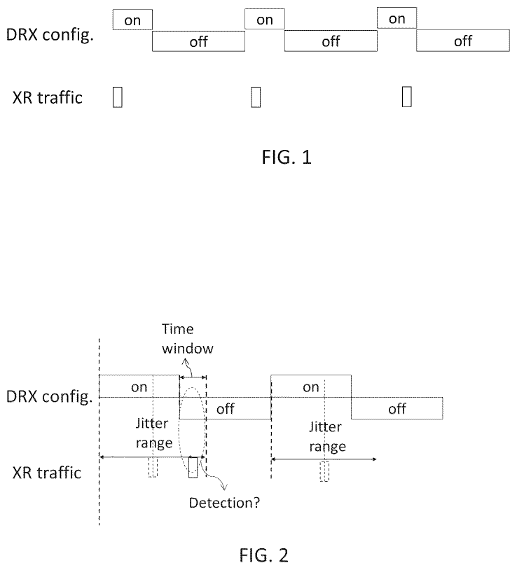

When the drx-onDurationTimer for the UE is running, the UE is considered as in the drx-on state shown in FIG. 1. In addition, it is possible that an inactivityTimer continues to run when the drx-onDurationTimer ends. The UE is considered as in active time (i.e. the drx-on state) when the drx-onDurationTimer or the inactivityTimer is running.

In some embodiments of determining a time to start a drx-onDurationTimer, the DRX mechanism is defined as follows:
1. if a Short DRX cycle (i.e. drx-ShortCycle) is used for a DRX group, and [(SFN×10)+subframe number] modulo (drx-ShortCycle)=(drx-StartOffset) modulo (drx-ShortCycle):
   start the drx-onDuration Timer for this DRX group after a drx-SlotOffset from the beginning of the subframe.
2. if a Long DRX cycle (i.e. drx-LongCycle) is used for a DRX group, and [(SFN×10)+subframe number] modulo (drx-LongCycle)=drx-StartOffset:
   start the drx-onDurationTimer for this DRX group after a drx-SlotOffset from the beginning of the subframe.

According to an embodiment, the radio resource control (RRC) controls DRX operation(s) by configuring the following parameters:
drx-onDurationTimer: the duration at the beginning of a DRX cycle;
drx-SlotOffset: the delay before starting the drx-onDuration Timer;
drx-InactivityTimer: the duration after the PDCCH monitoring occasion in which a PDCCH indicates a new UL or DL transmission for the MAC entity;
drx-RetransmissionTimerDL (per DL HARQ process except for the broadcast process): the maximum duration until a DL retransmission is received;
drx-RetransmissionTimerUL (per UL HARQ process): the maximum duration until a grant for UL retransmission is received;
drx-LongCycleStartOffset: the Long DRX cycle and drx-StartOffset which defines the subframe where the Long and Short DRX cycle starts;
drx-ShortCycle (optional): the Short DRX cycle;
drx-ShortCycleTimer (optional): the duration the UE shall follow the Short DRX cycle;
drx-HARQ-RTT-TimerDL (per DL HARQ process except for the broadcast process): the minimum duration before a DL assignment for HARQ retransmission is expected by the MAC entity;
drx-HARQ-RTT-TimerUL (per UL HARQ process): the minimum duration before a UL HARQ retransmission grant is expected by the MAC entity;

Note that the prefix of each parameter may be omitted in the present disclosure. For example, the drx-onDurationTimer is also named as onDurationTimer in this regard.

In addition, the drx-onDurationTimer and/or drx-InactivityTimer may be a duration or an exact timer that may run in the duration.

In the present disclosure, a period of time may be configured/defined via a high layer signaling (e.g. RRC signaling), to indicate a time interval of enabling the UE to monitor downlink control information (DCI) scheduling (e.g. physical downlink control channel (PDCCH)). For example, the UE is allowed to monitor the DCI scheduling in the period of time which may be out of onDuration Timer and/or inactivityTimer. In the present disclosure, the period of time configured by the high layer signaling to indicate a time interval of enabling the UE to monitor the DCI scheduling is also called “time period” or “time window” hereinafter.

FIG. 2 shows a schematic diagram of the configured time period according to an embodiment of the present disclosure. As shown in FIG. 2, the XR traffic is supposed to arrive at the gNB when the UE is within each DRX-on period. However, because of jitter, the XR traffic may arrive at the gNB when the UE may be within the DRX-off period. Under such conditions, the traffic needs to be transmitted in subsequent DRX-on period, resulting in a decrease in the network performance.

By being configured with the time period in which the UE is allowed to monitor the PDCCH (in the DRX-off period), the UE is ensured to detect the scheduling in corresponding PDCCH monitor occasion even if the scheduling is not transmitted until the configured/defined time period (because of the jitter). In addition, the mechanism is flexible for allowing the UE to perform the PDCCH monitoring during the configured time period on demand. Furthermore, legacy Power saving technology (e.g. DRX) can be applied in this case with considering influence of jitter and without increasing design complexity.

The operations/designs at UE side according to embodiments of the present disclosure are illustrated in the following.

### A. Receiving High Layer Signaling

In an example, the UE may receive a high layer signaling. In an embodiment, the high layer signaling may be an RRC signaling (e.g., “XR-r18”). The high layer signaling may be/comprises 1 bit being an indication of an existence of a XR-specific configuration and/or an indication of enabling the new functionality of the network.

For example, if the value of the bit is “1”, there is a XR-specific RRC configuration in the network. As an alternative or in addition, the value of the bit being “1” or “0” indicates that at least one of a DCI format configuration, a MAC CE configuration, is configured for the transmission or reception of control information.

As an alternative, the value of the bit is “1” or “0” to indicate that whether the service related configuration and/or 5G QoS Identifier (5QI) and/or a priority configuration is configured for the transmission or reception of control/data information.

In an example, the high layer signaling is configured per UE, per bandwidth part, and/or per cell.

For example, the RRC signaling (e.g., “XR-r18”) is broadcasted for a group of UEs or is unicasted to a UE.

B. Receiving the Specific RRC Configuration in which the Time Period is Configured

In an example, a specific RRC signaling is received for specific configuration of parameters, e.g. in the time domain. In an embodiment, the RRC signaling is transmitted for a DRX operation/configuration, more particularly for time-domain parameter(s) associated with the DRX operation/configuration.

In some embodiments, the UE-specific RRC signaling is configured per UE.

In an example, the time period/window is configured.

In some embodiments, a parameter associated with a duration of the time period/window is configured for configuring the period of time/time window. In addition, a parameter associated with a reference point or the first PDCCH monitoring occasion may also be configured in the RRC signaling. Note that the reference point or the first PDCCH monitoring occasion may be implicitly determined without the corresponding parameter (e.g. the reference point may be predefined).

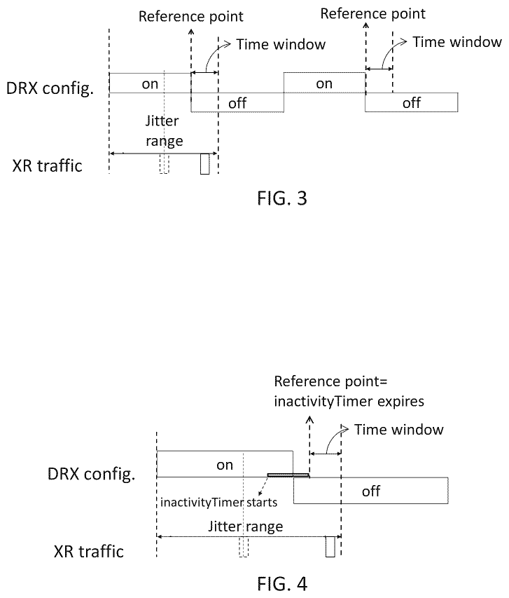

FIG. 3 shows a schematic diagram of the configured time window according to an embodiment of the present disclosure. In each DRX cycle shown in FIG. 3, the time period is configured to start from the end of the onDurationTimer and the duration of the period of time is also configured by the duration parameter. In this embodiment, the starting point of the time period is considered as the reference point, which can be derived from legacy DRX parameter(s) (e.g. onDurationTimer).

In some embodiments, the duration parameter is indicated by the number of Search space sets. For example, the duration (parameter) may be 2*n Search space sets, where n is a positive integer.

In some embodiments, the duration parameter is indicated by the number of PDCCH monitoring occasions. For example, the duration may be 2n PDCCH monitoring occasions, where n is an integer.

In some embodiments, the duration parameter is explicitly configured by the network. For example, the network may configure the duration parameter in a unit of millisecond (ms) or slot. In an embodiment, the duration may be ½, ⅓, ¼ of the duration of configured drx-onDurationTimer. As an alternative or in addition, the duration may be one or more PDCCH monitoring occasions or in a range from 1 ms to 16 ms.

In some embodiments, the time window starts at the first PDCCH monitoring occasion or the first symbol of the first slot after the end/expiry of onDurationTimer or the inactivityTimer.

FIG. 4 shows a schematic diagram of the time window according to an embodiment of the present disclosure. In FIG. 4, the time duration starts at the end/expiry of the inactivityTimer. That is the reference point is configured/predefined as the end/expiry of the inactivityTimer in this embodiment.

In some embodiments, the time window starts at the first PDCCH monitoring occasion in a slot n+k or at the first symbol of the slot n+k, where the onDuration Timer or the inactivityTimer ends in the slot n. In an embodiment, k is an integer. In these embodiments, a new parameter “k” is configured with the corresponding “duration” parameter.

In an embodiment, the unit of the configured parameter k may be millisecond, slot or symbol.

In an embodiment, the unit of the configured duration parameter can be millisecond or slot.

In some embodiments, the time window starts at the first PDCCH monitoring occasion in the slot n+k or the first symbol of the slot n+k, where the onDurationTimer or the inactivityTimer starts in the slot n. In an embodiment, k is an integer.

In some embodiments, the timer period starts or ends at the time which is a time offset after the first or the last CG PUSCH or SPS PDSCH resource. FIG. 5 shows a schematic diagram of the time window according to an embodiment of the present disclosure. In FIG. 5, the end of the time window is at the time point which is an offset after the last SPS PDSCH resource.

In some embodiments, the time period is configured by using absolute time having an SFN (system frame number) index/number and a slot index/number.

C. UE Activates the Time Window, or Activates a Timer or Re-Activates the inactivityTimer or Extending the onDuration Timer

In an example, an indication of whether to activate the time window/timers or not is configured.

In some embodiments, the UE receives, from the BS, the indication of whether to activate the configured time window/timer(s) associated with the time period.

In some embodiments, the indication comprises downlink control information (DCI), a DCI format, a DCI bit field, a MAC CE or a reference signal. In an embodiment, the DCI format may be a UE specific DCI format. In an embodiment, the DCI format is received in the last PDCCH monitoring occasion, in a time interval of a running onDurationTimer or a running inactivityTimer, in the first PDCCH occasion after an expiry of the onDurationTimer, or in a DRX-off period.

In some embodiments, the DCI may have the same format with DCI format 2_6 and further comprises the indication of whether to activate the time window/timers. In an embodiment, the DCI comprises a bit field indicating (1) whether to activate the time window/timers or not and/or (2) the duration of the time window/timer.

In some embodiments, the UE receives a MAC CE indicating whether to activate the time window/timer.

In some embodiments, the UE receives a Reference Signal indicating whether to activate the time window/timers or not. The reference signal may be a sounding reference signal (SRS), a channel state information reference signal (CSI-RS), a pseudo random (PN) sequence or a Zadoff chu (ZC) sequence.

In an example, a valid time of the indication may also be configured.

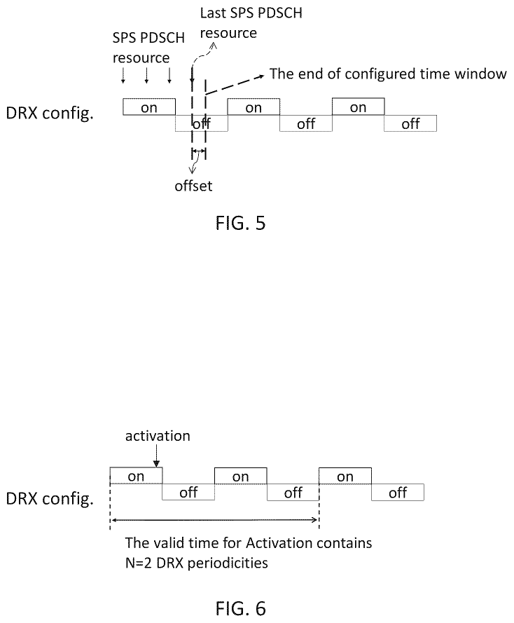

In some embodiments, the valid time for the activation of timer may be configured/defined. For example, the valid time refers to the number of DRX cycles in which the indication for whether to activate the time window/timers or not is valid. The valid time for activation may be configured as N DRX periods, where N is configurable (e.g. via high layer signaling). FIG. 6 shows a schematic diagram of the valid time for Activation of timer according to an embodiment of the present disclosure. In the embodiment shown in FIG. 6, N is configured/defined as 2. In FIG. 6, the timer is activated in the first DRX period. Because N is 2, the valid time for the activation of timer is 2 DRX periods. Thus, the timer is activated in both the first and the second DRX periods in FIG. 6.

In some embodiments, if the time window/timer for the UE is not activated, the UE enters the drx-off state when the onDurationTimer and/or inactivityTimer expires or when receiving related MAC CE indication.

In some embodiments, the indication of whether to activate the time window/timer associated with the time period may be an implicit indication. That is the UE determines to activate the timer if certain condition(s) is met/satisfied.

In some embodiments, the conditions associated with the implicit indication comprises at least one of:
The UE does not successfully detect the PDCCH with CRC scrambled by a new radio network temporary identifier (RNTI) until the onDurationTimer and/or inactivityTimer ends;
The onDurationTimer expires and the inactivityTimer does not start;
The inactivityTimer expires and exceeds the starting point of the time window;
There is PDCCH monitoring occasion for SPS/CG activation/deactivation in the time window.

In some embodiments, the new RNTI is allocated by the RRC signaling.

In some embodiments, the value of the new RNTI associated with the time period may be denoted by 16 bits.

In some embodiments, the new RNTI indicates a usage of (a property of XR e.g., quasi-periodic traffic) specific transmission. For example, when the new-RNTI is configured, the DCI CRC scrambled by using the new-RNTI is used as an indication of the (XR) specific traffic. In some embodiments, the new RNTI is used for scrambling cyclic redundancy check (CRC) of the DCI used for DCI monitoring for XR traffic/transmission (or for a property of XR, e.g., quasi-periodic traffic).

In an example, the UE performs PDCCH monitoring in the time window and/or when the timer is running.

In some embodiments, the UE monitors the DCI formats used for specific services (e.g. XR services and/or cloud computing services). For example, the DCI format used for specific service may comprise at least one of: DCI format 1_0, DCI format 0_0, DCI format 1_1, DCI format 0_1.

In some embodiments, the UE monitors the DCI formats which is CRC scrambled with an XR specific RNTI (i.e. the abovementioned new RNTI).

In some embodiments, the UE monitors the PDCCH when the inactivityTimer is restarted.

In some embodiments, the XR specific RNTI indicates the use of (a property of XR e.g., quasi-periodic traffic) specific transmission. In an embodiment, when the XR specific RNTI is configured, the DCI with the CRC scrambled by the XR specific RNTI is used to indicate the XR traffic/transmission.

In some embodiments, the XR-specific RNTI is used for scrambling the CRC of the DCI used for DCI monitoring for the XR traffic/transmission (or for a property of XR, e.g., quasi-periodic traffic).

In an example, the UE activates a new period of active time.

In some embodiments, the time period/window is defined as a new period of active time (e.g. DRX on-period). The BS indicates whether to activate the associated timer(s) via DCI, the MAC CE or a reference signal. In an embodiment, the valid time for Activation indication contains N DRX periodicities, N is configurable.

In some embodiments, a new period of active time is configured, and the UE determines whether to activate the timer or not if one of the conditions meets:
The UE does not monitor the PDCCH with the CRC scrambled by the new-RNTI till the onDurationTimer and/or the inactivityTimer ends;
The onDurationTimer expires and the inactivityTimer does not start;
The inactivityTimer expires and exceeds the starting point of the time window;
There is PDCCH monitoring occasion for SPS/CG activation/deactivation in the time window.

In some embodiments, the UE performs PDCCH monitoring for XR traffic transmission in the new period of active time.

For example, the UE monitors the DCI formats used for XR, such as DCI format 1-0, DCI format 0-0, DCI format 1-1 and DCI format 0-1. As an alternative or in addition, the UE monitors DCI formats which may be CRC scrambled with a XR specific RNTI (i.e. the new RNTI).

In some embodiments, the new period of active time can be implemented via extending the onDurationTimer. That is the same behavior as that associated with the onDurationTimer is performed by the UE in the new period of active time.

D. Activation of the monitoring of PDCCH

In some embodiments, if the UE does not successfully detect the PDCCH with the CRC scrambled by the new RNTI until onDurationTimer, and/or inactivityTimer ends, the UE starts or reactivates the inactivityTimer after the time when the onDuration Timer expires.

In some embodiments, if the UE does not successfully detect the PDCCH with the CRC scrambled by the new RNTI until the onDurationTimer or the inactivity Timer ends, the UE reactivates the inactivityTimer after the inactivityTimer expires.

In some embodiments, the UE starts the inactivityTimer at next slot or a millisecond after the the onDuration Timer expires, if the onDurationTimer expires and the inactivityTimer does not start.

In some embodiments, the new RNTI is allocated by an RRC signaling.

In some embodiments, the value of the new RNTI associated with the time period may be denoted by 16 bits.

In some embodiments, the new RNTI indicates a usage of (a property of XR e.g., quasi-periodic traffic) specific transmission. For example, when the new-RNTI is configured, the DCI CRC scrambled by using the new-RNTI is used as an indication of the (XR) specific traffic/transmission. In some embodiments, the new RNTI is used for scrambling cyclic redundancy check (CRC) of the DCI used for DCI monitoring for XR traffic (or for a property of XR, e.g., quasi-periodic traffic).

In the following, the operations/mechanisms at the BS side are illustrated.

### A. High Layer Signaling Indication

In some embodiments, the BS (e.g. gNB) transmits a high layer signaling associated with the time window to the UE. The high layer signaling may be an RRC signaling (e.g., “XR-r18”). The RRC signaling may comprise 1 bit for indicating an existence of the XR-specific configuration and/or enabling an associated functionality of the network.

In some embodiments, the high layer signaling is configured Per UE, bandwidth part, or per cell.

### B. Specific RRC Configuration

In an example, the BS transmits a specific RRC signaling for configuring specific configuration of parameters, e.g. in the time domain. In an embodiment, the RRC signaling is transmitted for a DRX operation/configuration, more particularly for configuring time-domain parameter(s) associated with the DRX operation/configuration.

In some embodiments, the UE-specific RRC signaling is configured per UE.

The designs of the RRC configuration from the BS are similar to that of the RRC configuration for the UE. Thus, the designs of the RRC configuration for the BS can refer to above section B for the UE.

### C. Transmission of PDCCH in the Time Window

In some embodiments, the BS (e.g. gNB) transmits a signaling to the UE, to indicate the UE whether to activate the configured time window/timers.

In some embodiments, the indication comprises DCI, a DCI format, a DCI bit field, a MAC CE or a reference signal. In an embodiment, the DCI format may be a UE specific DCI format. In an embodiment, the DCI format is transmitted in a time interval of a running onDurationTimer or a running inactivityTimer, in the first PDCCH occasion after an expiry of the onDurationTimer, or in a DRX-off period.

In some embodiments, the DCI may be a DCI format 2_x, or have the same format with DCI format 2_6 and further comprises the indication of whether to activate the time window/timers. In an embodiment, the DCI comprises a bit field indicating (1) whether to activate the time window/timers or not and/or (2) the duration of the time window/timer. In an embodiment, the bit field may contain 2 bits, or 3 bits. In an embodiment, the duration and is whether to activate the time window are jointly indicated. In another embodiment, the bit field indicates the duration of the time window, wherein the length of the duration can be one of candidate values. For example, the candidate values for the length of the duration can be ½, ⅓, ¼ of the length of the configured onDuration Timer.

In some embodiments, the UE receives a MAC CE indicating whether to activate the time window/timer.

In some embodiments, the UE receives a Reference Signal indicating whether to activate the time window/timers or not. The reference signal may be an SRC, a CSI-RS, a PN sequence or a ZC sequence.

In an example, a valid time of the indication may also be configured.

In some embodiments, the valid time for the activation of timer may be configured/defined. For example, the valid time refers to the number of DRX cycles in which the indication for whether to activate the time window/timers or not is valid. The valid time for activation may be configured as N DRX periods, where N is configurable (e.g. via high layer signaling). In an embodiment, the network reuses legacy PDCCH monitoring skipping SSSG with extension of value range to DRX-off time, for purpose of saving power.

For example, a denser search space set is used for PDCCH monitoring in the time window/timer.

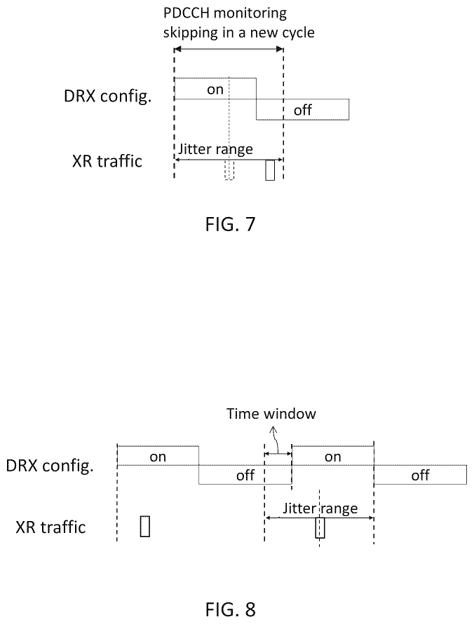

In an embodiment, the BS indicates a PDCCH monitoring skipping/SSSG in a new DRX cycle. FIG. 7 shows a schematic diagram of the PDCCH monitoring skipping/SSSG according to an embodiment of the present disclosure. In FIG. 7, the gNB indicates the PDCCH monitoring skipping/SSSG in the new cycle, where the configured time window for the PDCCH monitoring in original DRX-off period is included. In an embodiment, dynamical change of periodicity of search space set may be configured for the monitoring in the time window.

In an embodiment, the BS configures the time window and the UE monitors the PDCCH in the time window if the time window is configured before a start of the onDurationTimer. For example, the UE monitors the PDCCH in the time window if the time window is configured several slots before the onDurationTimer is started. FIG. 8 shows a schematic diagram of time window according to an embodiment of the present disclosure. In FIG. 8, the BS configures the time window several slots before the start of the onDurationTimer (i.e. before next DRX on-period). Thus, the UE monitors the PDCCH in the time window in this embodiment.

In an embodiment, only slots with even or odd numbers/indexes are used for the PDCCH monitoring in the time window.

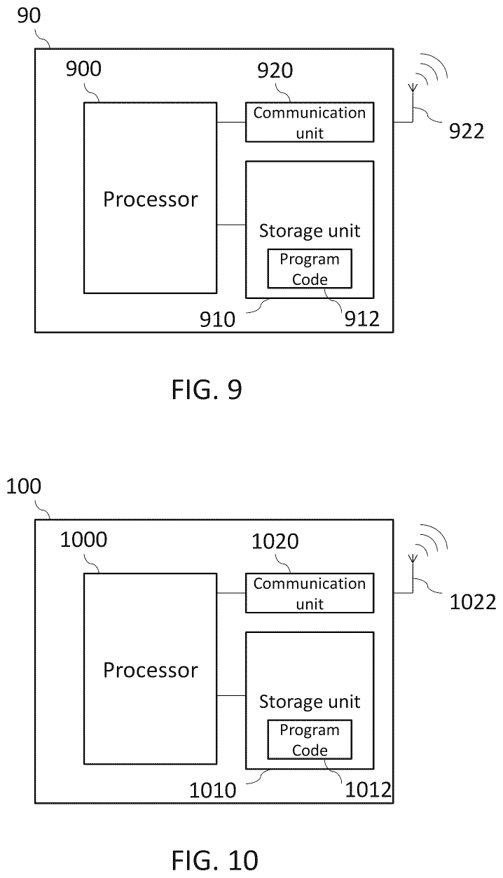

FIG. 9 relates to a schematic diagram of a wireless terminal 90 according to an embodiment of the present disclosure. The wireless terminal 90 may be a user equipment (UE), a mobile phone, a laptop, a tablet computer, an electronic book or a portable computer system and is not limited herein. The wireless terminal 90 may include a processor 900 such as a microprocessor or Application Specific Integrated Circuit (ASIC), a storage unit 910 and a communication unit 920. The storage unit 910 may be any data storage device that stores a program code 912, which is accessed and executed by the processor 900. Embodiments of the storage unit 910 include but are not limited to a subscriber identity module (SIM), read-only memory (ROM), flash memory, random-access memory (RAM), hard-disk, and optical data storage device. The communication unit 920 may a transceiver and is used to transmit and receive signals (e.g. messages or packets) according to processing results of the processor 900. In an embodiment, the communication unit 920 transmits and receives the signals via at least one antenna 922 shown in FIG. 9.

In an embodiment, the storage unit 910 and the program code 912 may be omitted and the processor 900 may include a storage unit with stored program code.

The processor 900 may implement any one of the steps in exemplified embodiments on the wireless terminal 90, e.g., by executing the program code 912.

The communication unit 920 may be a transceiver. The communication unit 920 may as an alternative or in addition be combining a transmitting unit and a receiving unit configured to transmit and to receive, respectively, signals to and from a wireless network node (e.g. a base station).

FIG. 10 relates to a schematic diagram of a wireless network node 100 according to an embodiment of the present disclosure. The wireless network node 100 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 100 may comprise (perform) at least one network function such as an access and mobility management function (AMF), a session management function (SMF), a user place function (UPF), a policy control function (PCF), an application function (AF), etc. The wireless network node 100 may include a processor 1000 such as a microprocessor or ASIC, a storage unit 1010 and a communication unit 1020. The storage unit 1010 may be any data storage device that stores a program code 1012, which is accessed and executed by the processor 1000. Examples of the storage unit 1010 include but are not limited to a SIM, ROM, flash memory, RAM, hard-disk, and optical data storage device. The communication unit 1020 may be a transceiver and is used to transmit and receive signals (e.g. messages or packets) according to processing results of the processor 1000. In an example, the communication unit 1020 transmits and receives the signals via at least one antenna 1022 shown in FIG. 10.

In an embodiment, the storage unit 1010 and the program code 1012 may be omitted. The processor 1000 may include a storage unit with stored program code.

The processor 1000 may implement any steps described in exemplified embodiments on the wireless network node 100, e.g., via executing the program code 1012.

The communication unit 1020 may be a transceiver. The communication unit 1020 may as an alternative or in addition be combining a transmitting unit and a receiving unit configured to transmit and to receive, respectively, signals to and from a wireless terminal (e.g. a user equipment or another wireless network node).

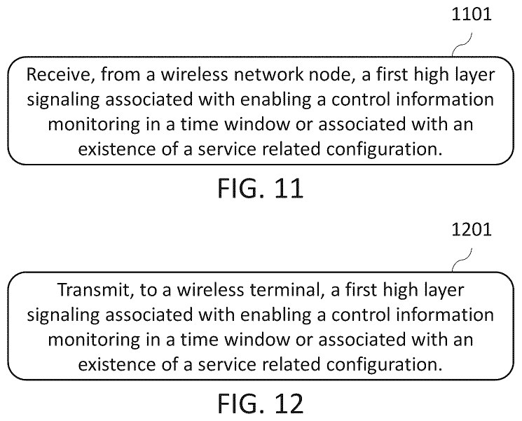

FIG. 11 shows a flowchart of a method according to an embodiment of the present disclosure. The method shown in FIG. 11 may be used in a wireless terminal (e.g. UE) and comprises the following step:

Step 1101: Receive, from a wireless network node, a first high layer signaling associated with enabling a control information monitoring in a time window or associated with an existence of a service related configuration.

In the embodiment of FIG. 11, the wireless terminal receives a first high layer signaling (e.g. RRC signaling) from a wireless network node. The first high layer signaling is associated with enabling a control information monitoring in a time window or associated with an existence of a service related configuration (e.g. XR service configuration). Based on the first high layer signaling, the wireless terminal may monitor control information (e.g. DCI, PDCCH) in the time window. For example, the time window may be at least partially outside of the active time of DRX (e.g. DRX on-period).

In some embodiments, the first high layer signaling comprises a bit indicating whether the service related configuration exists.

In some embodiments, the first high layer signaling is broadcasted or unicasted to the wireless terminal.

In some embodiments, the wireless terminal receives a second high layer signaling from the wireless network node, wherein the second high layer signaling configures the time window for the control information monitoring. Note that the second high layer signaling may be the first high layer signaling. That is the first high layer signaling may be used to configure the time window for the control information monitoring.

In an embodiment, the second high layer signaling configures the time window by configuring at least one of a duration parameter indicating a duration of the time window or a reference point parameter associated with determining a starting point of the time window.

In an embodiment, the second high layer signaling configures the time window by configuring a duration parameter indicating a duration of the time window.

In an embodiment, the duration parameter indicates the duration by indicating a number of search space sets, a number of PDCCH MOs, a number of slots or a time-domain value (e.g. ms).

In some embodiments, the time window is configured to start at:
the first PDCCH MO, or
the first symbol of the first slot after an expiry of the onDurationTimer or the inactivityTimer.

In some embodiments, the first PDCCH MO in the time window or the first slot of the time window is after a time instant which is a time offset after a slot at which the onDurationTimer or the inactivityTimer starts or ends.

In some embodiments, a unit of the time offset is ms or slot.

In some embodiments, a starting point the time window is determined based on a start or an end of an onDurationTimer.

In some embodiments, the time window starts or ends at a time instant having a time offset with respect to a time-domain resource of the last CG-PUSCH or the last SPS-PDSCH.

In some embodiments, the wireless terminal receives a third high layer signaling from the wireless network node, wherein the third high layer signaling indicates at least one of an SFN index, a subframe index and a slot index as the starting point of the time window. In an embodiment, the third high layer signaling may be the first high layer signaling. In other words, the first high layer signaling may also indicate the starting point of the time window.

In some embodiments, the wireless terminal activates the control information monitoring in the time window.

In some embodiments, the wireless terminal activates a timer (e.g. onDuration Timer or inactivityTimer) associated with the time window, wherein the activated timer is configured by an RRC signaling.

In an embodiment, the wireless terminal may further receive, from the wireless network node, an indication associated with activating time window or the timer. For example, the indication may be/comprise DCI, a DCI format, a DCI bit field, a MAC CE or a reference signal.

In an embodiment of the indication being the DCI, the DCI is received in:
the last PDCCH MO in a timer interval of a running onDurationTimer or a running inactivityTimer, or
the first PDCCH MO after an expiry of the onDurationTimer or in a DRX-off period.

In an embodiment, the indication is configured with a valid time indicating a number of DRX cycles in which the indication is valid.

In an embodiment, the wireless terminal activates the control information monitoring in the time window or activates the timer associated with the time window by:
activating the control information monitoring in the time window or the timer when at least one of following events occurs:
   detecting no physical downlink control channel with a cyclic redundancy check scrambled by a radio network temporary indicator allocated for a specific (traffic) transmission before an onDurationTimer or an inactivityTimer expires,
   an onDuration Timer expires and an inactivityTimer is not activated,
   an inactivityTimer expires and a starting point of the time window has passed,
   a physical downlink control channel monitoring occasion for an activation/deactivation of a configured grant or a semi persistent scheduling is in the time window.

In some embodiments, the wireless terminal further monitors a PDCCH when a behavior of monitoring control information in the time window is activated or the activated timer is running.

In an embodiment, the monitored PDCCH comprises at least one of a DCI format configured for a specific transmission or a DCI format having a CRC scrambled by an RNTI allocated for the specific transmission. For example, the specific transmission is a quasi-periodic traffic or an XR traffic.

In some embodiments, the wireless terminal monitors a PDCCH in a period of non-active time (e.g. DRX off-period) when:
the wireless terminal does not detect a PDCCH with a CRC scrambled by an RNTI allocated for the specific (traffic) transmission before the onDurationTimer or the inactivityTimer expires, or
the onDurationTimer expires and the inactivityTimer is not activated.

In an embodiment, the monitored PDCCH comprises at least one of:
a DCI format configured for the specific transmission,
a DCI format having a CRC scrambled by an RNTI allocated for the specific transmission. For example, the specific transmission is a quasi-periodic traffic or an XR traffic.

In some embodiments, the wireless terminal starts an inactivityTimer after an onDurationTimer expires when the onDurationTimer expires and the inactivity Timer does not start.

In some embodiments, the wireless terminal starts an inactivityTimer after an onDurationTimer expires when detecting no PDCCH with a CRC scrambled by an RNTI allocated for a specific (traffic) transmission before the onDurationTimer or the inactivityTimer expires. For example, the specific transmission is a quasi-periodic traffic or an XR traffic.

FIG. 12 shows a schematic diagram of a method according to an embodiment of the present disclosure. The method shown in FIG. 12 may be used in a wireless network node (e.g. BS, gNB) and comprises the following step:

Step 1201: Transmit, to a wireless terminal, a first high layer signaling associated with enabling a control information monitoring in a time window or associated with an existence of a service related configuration.

In this embodiment, the wireless network node transmits a first high layer signaling (e.g. RRC signaling) to a wireless terminal (e.g. UE). The first high layer signaling is associated with enabling a control information monitoring in a time window or associated with an existence of a service related configuration (e.g. configuration related to XR service). The wireless network node may transmit a PDCCH in the time window.

In some embodiments, the first high layer signaling comprises a bit indicating whether the service related configuration exists.

In some embodiments, the first high layer signaling is broadcasted or unicasted to the wireless terminal.

In some embodiments, the wireless network node transmits a second high layer signaling to the wireless terminal, wherein the second high layer signaling configures the time window for the control information monitoring. Note that the second high layer signaling may be the first high layer signaling. That is the first high layer signaling may also be used to configure the time window for the control information monitoring.

In an embodiment, the second high layer signaling configures the time window by configuring at least one of a duration parameter indicating a duration of the time window or a reference point parameter associated with determining a starting point of the time window.

In an embodiment, the second high layer signaling configures the time window by configuring a duration parameter indicating a duration of the time window.

In an embodiment, the duration parameter indicates the duration by indicating a number of search space sets, a number of PDCCH MOs, a number of slots or a time-domain value (e.g. ms).

In some embodiments, the time window is configured to start at:
the first PDCCH MO, or
the first symbol of the first slot after an expiry of the onDurationTimer or the inactivityTimer.

In some embodiments, the first PDCCH MO in the time window or the first slot of the time window is after a time instant which is a time offset after a slot at which the onDurationTimer or the inactivityTimer starts or ends.

In some embodiments, a unit of the time offset is ms or slot.

In some embodiments, a starting point of the time window is determined based on a start or an end of an onDuration Timer.

In some embodiments, the time window starts or ends at a time instant having a time offset with respect to a time-domain resource of the last CG-PUSCH or the last SPS-PDSCH.

In some embodiments, the wireless network node transmits a third high layer signaling to the wireless terminal, wherein the third high layer signaling indicates at least one of an SFN index, a subframe index and a slot index as the starting point of the time window. In an embodiment, the third high layer signaling may be the first high layer signaling. In other words, the first high layer signaling may also indicate the starting point of the time window.

In some embodiments, the wireless network node transmits the control information (e.g. PDCCH) being monitored in the time window.

In some embodiments, the wireless network node transmits the indication to activate a timer in the time window, wherein the activated timer is configured by an RRC signaling.

In an embodiment, the timer is the onDurationTimer or the inactivity Timer.

In an embodiment, the indication is/comprises DCI, a DCI format, a DCI bit field, a MAC CE or a reference signal.

In an embodiment of the indication being the DCI, the DCI is transmitted in the DCI is transmitted in:
the last PDCCH MO in a timer interval of a running onDurationTimer or a running inactivityTimer, or
the first PDCCH MO after an expiry of the onDurationTimer or in a DRX-off period.

In an embodiment, the indication is configured with a valid time indicating a number of DRX cycles in which the indication is valid.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

1. A wireless communication method for use in a wireless terminal, the method comprising:
receiving, from a wireless network node, a first high layer signaling associated with enabling a control information monitoring in a time window or associated with an existence of a service related configuration.

2. The wireless communication method of claim 1, wherein the first high layer signaling is a radio resource control signaling.

3. The wireless communication method of claim 1, wherein the first high layer signaling comprises a bit indicating whether the service related configuration exists.

4. The wireless communication method of claim 1, wherein the first high layer signaling is broadcasted or unicasted to the wireless terminal.

5. The wireless communication method of claim 1, further comprising:
receiving, from the wireless network node, a second high layer signaling configuring the time window for the control information monitoring.

6. The wireless communication method of claim 5, wherein the second high layer signaling configures the time window by configuring at least one of a duration parameter indicating a duration of the time window or a reference point parameter associated with determining a starting point of the time window.

7. The wireless communication method of claim 5, wherein the second high layer signaling configures the time window by configuring a duration parameter indicating a duration of the time window.

8. The wireless communication method of claim 6, wherein the duration parameter indicates the duration by indicating a number of search space sets, a number of physical downlink control channel monitoring occasions, a number of slots or a time-domain value.

9. The wireless communication method of claim 1, wherein the time window is configured to start at a first physical downlink control channel monitoring occasion or at a first symbol of a first slot after an expiry of an onDurationTimer or an inactivityTimer.

10. The wireless communication method of claim 1, wherein a first physical downlink control channel monitoring occasion in the time window or a first slot of the time window is after a time instant which is a time offset after a slot at which an onDurationTimer or an inactivity Timer starts or ends.

11. The wireless communication method of claim 10, wherein a unit of the time offset is millisecond or slot.

12. The wireless communication method of claim 1, wherein a starting point of the time window is determined based on a start or an end of an onDurationTimer.

13. The wireless communication method of claim 1, wherein the time window starts or ends at a time instant having a time offset with respect to a time-domain resource of a last configured grant physical uplink shared channel or a last semi persistent scheduling physical downlink shared channel.

14. The wireless communication method of claim 1, further comprising:
receiving, from the wireless network node, a third high layer signaling indicating at least one of a system frame number index, a subframe index and a slot index as a starting point of the time window.

15. The wireless communication method of claim 1, further comprising:
activating the control information monitoring in the time window, or
activating a timer associated with the time window, wherein the activated timer is configured by an RRC signaling.

16. The wireless communication method of claim 15, wherein the timer is an onDuration Timer or an inactivity Timer.

17. The wireless communication method of claim 15, further comprising:
receiving, from the wireless network node, an indication associated with activating time window or the timer.

18. The wireless communication method of claim 17, wherein the indication comprises downlink control information, DCI, a DCI format, a DCI bit field, a media access control control element, MAC CE, or a reference signal.

19. A wireless communication method for use in a wireless network node, the method comprising:
transmitting, to a wireless terminal, a first high layer signaling associated with enabling a control information monitoring in a time window or associated with an existence of a service related configuration.

20. A wireless terminal, comprising:
a communication unit, configured to receive, from a wireless network node, a first high layer signaling associated with enabling a control information monitoring in a time window or associated with an existence of a service related configuration.
